(19) United States
(12) Patent Application Publication
(10) Pub. No.: US 2018/0270391 A1
(43) Pub. Date: Sep. 20, 2018

(54) IMAGE PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Asako Sugahara, Urayasu-shi (JP)

(21) Appl. No.: 15/910,870

(22) Filed: Mar. 2, 2018

(30) Foreign Application Priority Data
Mar. 15, 2017 (JP) 2017-050289

(51) Int. Cl. H04N 1/40; G06K 15/02; H04N 1/00

(52) U.S. Cl. CPC H04N 1/40087; H04N 1/00326; G06K 15/1835; H04N 1/40012

(57) ABSTRACT

An image processing apparatus extracts, from color image data, an object having a first density and an object having a second density being higher than the first density, and determines whether or not sizes of the objects each having the first density and the second density are greater than a predetermined size. When converting the color image data into monochromatic image data, an object having the first density and a size less than or equal to the predetermined size is converted to have a higher density than an object having the first density and a size greater than the predetermined size, and an object having the second density and a size less than or equal to the predetermined size is converted to have the same density as an object having the second density and a size greater than the predetermined size.

### BACKGROUND OF THE INVENTION

### Field of the Invention

The present invention relates to an image processing apparatus, a method of controlling the same, and a storage medium.

### Description of the Related Art

Lately, written materials, documents for presentations, and the like are typically created in full color. However, documents that are originally in color are often printed in black and white to reduce costs. Thus when printing a color image in black and white, a process for converting the color data into gray scale data must be carried out. If the original color data is RGB, for example, the conversion process normally uses a color-to-gray conversion method, in which a formula that converts the RGB values into a luminance signal (Y) is used, and the obtained values are gray values corresponding to the original color values. When such color-to-gray conversion is used, there is a problem in that depending on the original color values, the image output in black and white will be too light, have poor visibility, or the like. Japanese Patent Laid-Open No. H11-129547 discloses a technique in which, if text will be too light as the result of color-to-gray conversion, width-increasing processing is carried out on text greater than or equal to a set size. The width-increasing processing is not carried out on smaller text, however, because doing so would make the text illegible.

However, the conventional method cannot improve the visibility of small-sized text (small-point text). There is a further issue in that small-point text appears lighter than large-sized text (large-point text) even when the text has the same density.

### SUMMARY OF THE INVENTION

An aspect of the present invention is to eliminate the above-mentioned problem with conventional technology.

A feature of the present invention is to provide a technique for improving the visibility of objects having a size less than or equal to a predetermined value when outputting color image data in black and white.

According to a first aspect of the present invention, there is provided an image processing apparatus comprising: a memory device that stores a set of instructions; and at least one processor that executes instructions stored in the memory device to function as: an extracting unit that extracts, from color image data, an object having a first density and an object having a second density that is higher than the first density; a determining unit that determines whether or not a size of the object having the first density and a size of the object having the second density, extracted by the extracting unit, are greater than a predetermined size; and a converting unit that converts the color image data into monochromatic image data, wherein the converting unit carries out conversion so that an object having the first density and a size less than or equal to the predetermined size has a higher density than an object having the first density and a size greater than the predetermined size; and carries out conversion so that an object having the second density and a size less than or equal to the predetermined size has the same density as an object having the second density and a size greater than the predetermined size.

According to a second aspect of the present invention, there is provided an image processing apparatus that generates monochromatic image data on the basis of print data including a command to draw a chromatic colored object, the apparatus comprising: a memory device that stores a set of instructions; and at least one processor that executes instructions stored in the memory device to function as: a receiving unit that receives print data including at least a first drawing command for drawing a first chromatic colored object and a second drawing command for drawing a second chromatic colored object; a determining unit that determines whether or not a size of the first chromatic colored object and a size of the second chromatic colored object are greater than a predetermined size; a converting unit that converts the first drawing command into a third drawing command for drawing a monochromatic image of a first chromatic colored object determined to have a size less than or equal to the predetermined size so that the first chromatic colored object has a higher density, after being converted into a monochromatic image, than a first chromatic colored object determined to have a size greater than the predetermined size, and converts the second drawing command into a fourth drawing command for drawing a monochromatic image of a second chromatic colored object determined to have a size less than or equal to the predetermined size so that the second chromatic colored object has the same density, after being converted into a monochromatic image, as a second chromatic colored object determined to have a size greater than the predetermined size; and a generating unit that generates monochromatic image data by executing the third drawing command and the fourth drawing command obtained from the conversion by the converting unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for describing the configuration of an image forming apparatus according to a first embodiment of the present invention.

FIG. 2 is a diagram for describing the flow of a printing process in the image forming apparatus according to the first embodiment.

FIG. 3 is a flowchart for describing a color conversion process performed by the image forming apparatus according to the first embodiment.

FIG. 4 is a diagram for describing commands included in print data received by the image forming apparatus, an example of the conversion thereof, and an example of a drawing result based thereon, according to the first embodiment.

FIG. 5 is a diagram for describing an example of a density adjustment graph used to obtain a density adjustment amount, according to the first embodiment.

FIG. 6 is a flowchart for describing a color conversion process performed by an image forming apparatus according to a second embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

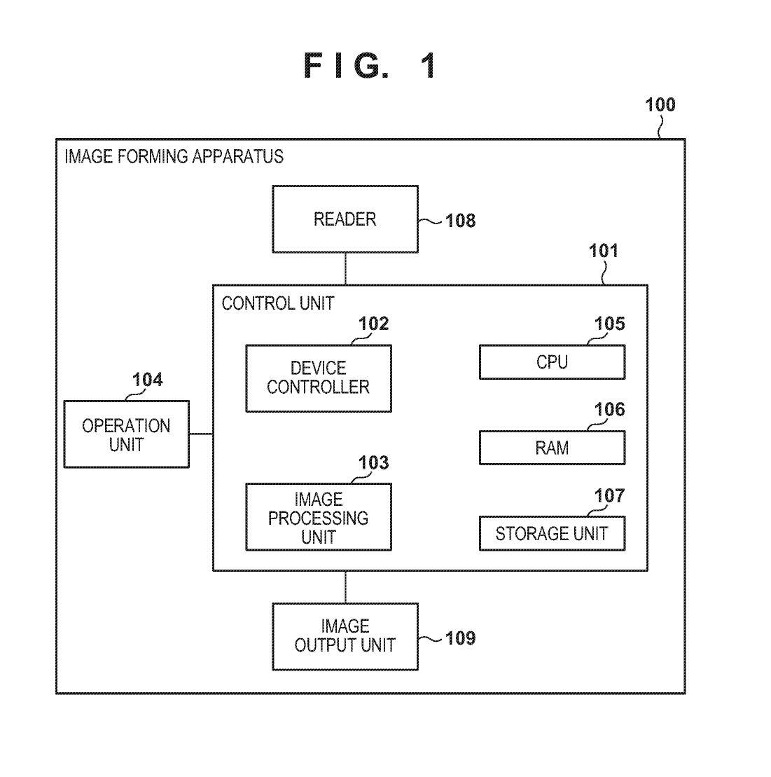

FIG. 1 is a block diagram for describing the configuration of an image forming apparatus 100 according to a first embodiment of the present invention.

The image forming apparatus 100 is an example of an image processing apparatus according to the present invention, and is a multifunction peripheral (MFP) that integrates multiple functions such as a scanning function and a printing function. A control unit 101 comprehensively controls the image forming apparatus 100, and includes a CPU 105, RAM 106, a storage unit 107, a device controller 102, and an image processing unit 103. The CPU 105 controls operations of the image forming apparatus 100 by deploying programs stored in the storage unit 107 into the RAM 106 and executing those programs. The RAM 106 is temporary storage memory that can temporarily store image data, programs, and so on. The storage unit 107 is a hard disk, for example, that stores parameters for controlling the image forming apparatus 100, as well as applications, programs, an OS, and so on for implementing the control according to the embodiments. The device controller 102 controls elements connected to the control unit 101, such as an operation unit 104, a reader 108, and an image output unit 109. The reader 108 is a scanner, for example, and the image output unit 109 is a printer, for example. The scanning function, which obtains image data of a document read by the reader 108, an output function, which outputs an image to a recording medium such as paper or a monitor via the image output unit 109, and so on are realized by the CPU 105 executing the above-described programs. The image processing unit 103 reads out image data stored in the storage unit 107, for example, optimizes the image data in accordance with parameters, carries out image processing on the basis of setting information communicated from the operation unit 104, and so on. The operation unit 104 includes a touch panel, hardware keys, and so on, accepts instructions, setting operations, and so on from a user, and displays device information of the image forming apparatus 100, progress information of jobs, and various types of user interface screens. The setting information and so on accepted by the operation unit 104 is stored in the storage unit 107 via the device controller 102. Blocks required to execute functions of the image forming apparatus 100 are also included as appropriate, in addition to the blocks illustrated in FIG. 1. These blocks include, for example, a network interface including a router, a firewall, and so on, and the apparatus is communicatively connected to an external PC or server by this interface.

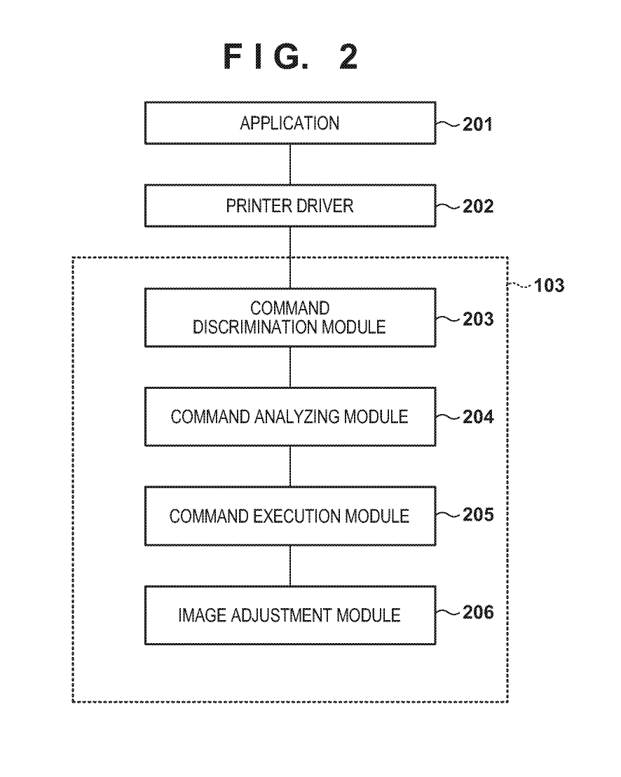

FIG. 2 is a diagram for describing the flow of a printing process in the image forming apparatus 100 according to the first embodiment.

An application 201 is installed in an external device (a PC or the like; not illustrated), and electronic data such as a written document or a presentation document is created on that external device using the application 201. A printer driver 202 is a printer driver installed in the external device, and is a driver for outputting print data (color image data) to the image forming apparatus 100 to be printed. The print data created by the printer driver 202 is sent to the image forming apparatus 100 and printed.

The print data is processed by the image processing unit 103 of the image forming apparatus 100. Upon receiving the print data, the image forming apparatus 100 discriminates between PDL types using a command discrimination module 203. “PDL type” includes PostScript (PS), Printer Command Language (PCL), and so on. A command analyzing module 204 is provided for each PDL type, and extracts and analyzes commands of the PDL type identified by the command discrimination module 203. A gray conversion process and the like are carried out in accordance with the details of the analyzed commands. A command execution module 205 generates a raster image in accordance with the analysis result from the command analyzing module 204. An image adjustment module 206 applies image processing such as color conversion and filtering to the raster image. Note that the functions of the command discrimination module 203, the command analyzing module 204, the command execution module 205, and the image adjustment module 206 of the image processing unit 103 illustrated in FIG. 2 are in the present embodiment realized by the CPU 105 executing the above-described programs.

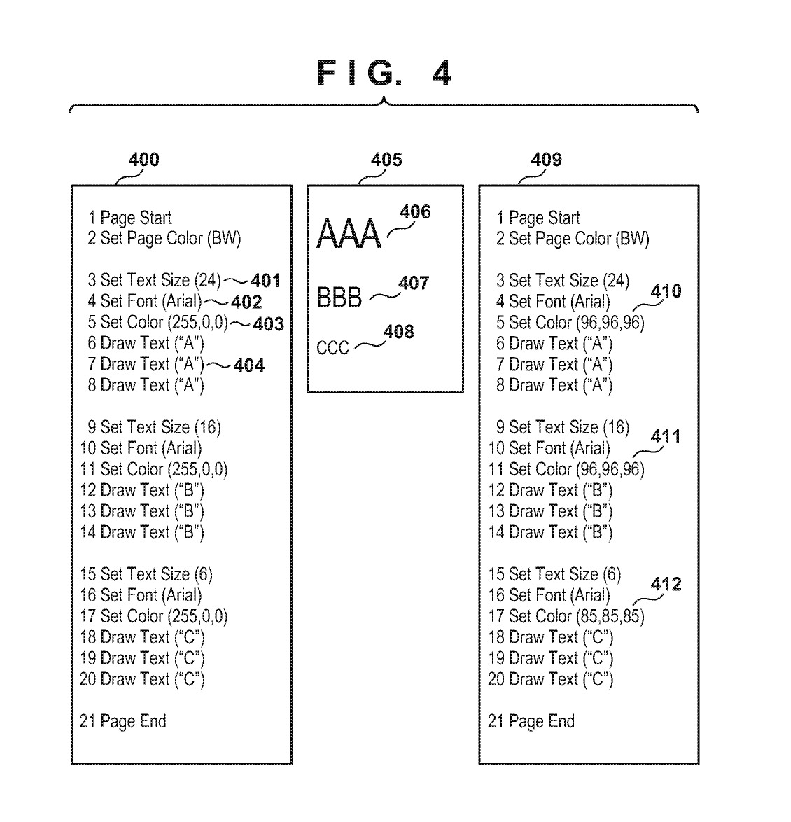

FIG. 4 is a diagram for describing commands included in the print data received by the image forming apparatus 100, an example of the conversion thereof, and an example of a drawing result based thereon, according to the first embodiment.

The commands include a drawing command and a control command, and a drawing command 400 is an example of the drawing command. An image 405 corresponds to an image drawn using the drawing command 400. The drawing command 400 includes a text size setting command 401 that sets the size of text, a font setting command 402 that sets the font of the text, a color setting command 403 that sets a color, and a text drawing command 404 that draws the text. The structure of this series of commands is the same for other text strings (text strings BBB and CCC, in the example of FIG. 4). Commands and the like for setting coordinates, the weight of lines, and so on are also included, but these are not illustrated here.

The content of the drawing command 400 will be described briefly. “Set Page Color(BW)” indicates that the commands following thereafter are to be deployed in black and white. The text size setting command “SetText Size(24)” indicates that the text size is 24 point, and the font setting command “Set Font (Arial)” indicates that the text font is Arial. The color setting command “Set Color(255, 0, 0)” indicates that the color is black, and the text drawing command “Draw Text(“A”)” indicates that the letter “A” is to be drawn. Thus the third to eighth commands in the drawing command 400 indicate that three of the letter “A” are to be drawn in Arial front, at 24 point, and in black.

Likewise, the ninth to 14th commands in the drawing command 400 indicate that three of the letter “B” are to be drawn in Arial front, at 16 point, and in black. Furthermore, the 15th to 20th commands indicate that three of the letter “C” are to be drawn in Arial front, at 6 point, and in black.

As such, the text string AAA in the image 405, indicated by 406, is drawn in response to the third to eighth commands in the drawing command 400, and the text string BBB in the image 405, indicated by 407, is drawn in response to the ninth to 14th commands. Furthermore, the text string CCC in the image 405, indicated by 408, is drawn in response to the 15th to 20th commands. The foregoing is an example of the printing process, and in the first embodiment, descriptions will be given assuming this processing flow.

Gray conversion processing of small-point text, which is a feature of the first embodiment, will be described next.

When color text is converted to gray, small-point text will appear lighter than large-point text even if the small-point text has the same density as the large-point text. Adjusting small-point text to have an appearance similar to large-point text by raising the density of the small-point text is a feature of the first embodiment.

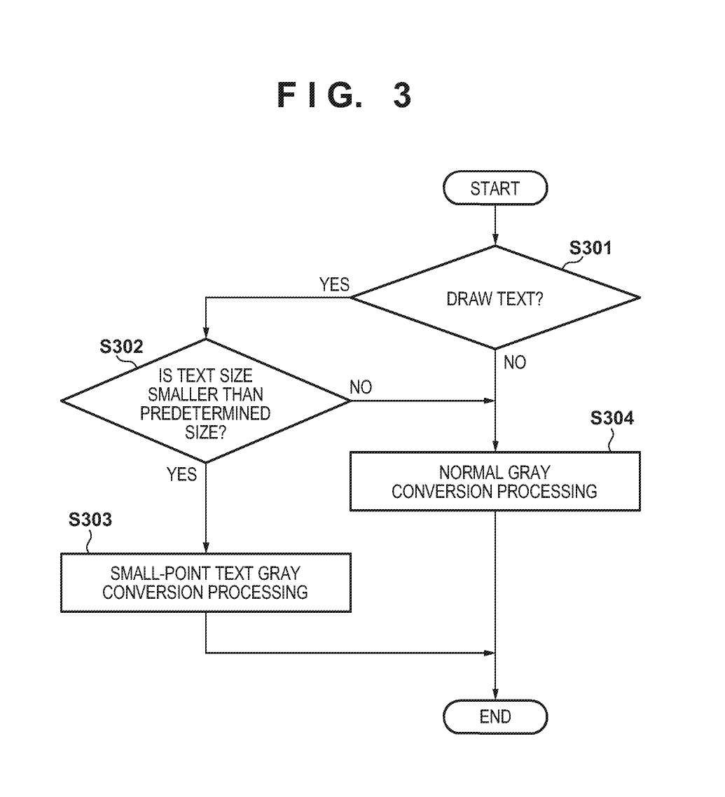

FIG. 3 is a flowchart for describing a color conversion process performed by the image forming apparatus 100 according to the first embodiment. Note that the processing indicated in this flowchart is achieved by the CPU 105 deploying a program stored in the storage unit 107 into the RAM 106 and executing the deployed program. Additionally, as described above, it is assumed that the gray conversion processing according to the first embodiment is executed by the CPU 105 as a function of the command analyzing module 204. These descriptions will be given assuming a drawing command 400 designating black-and-white, such as that illustrated in FIG. 4, has been received.

First, in step S301, the CPU 105 determines whether or not the drawing command includes a drawing command for text. If it is determined that a drawing command for text is not included, the processing advances to step S304, where the CPU 105 carries out normal gray conversion processing and ends the sequence. In the normal gray conversion processing, an RGB signal in which the color setting command (“Set Color(255, 0, 0)”) is designated becomes a signal blended at a predetermined balance for an equal RGB amount. Here, “Set Color(255, 0, 0)” is converted to “Set Color(96, 96, 96)”, as indicated by color setting commands 410 and 411 in a post-processing drawing command 409 indicated in FIG. 4, for example. In other words, the color setting command designating “Set Color(255, 0, 0)” in the drawing command 400 is blended at a ratio of R:G:B=3:4:1, and is converted into a normal gray-converted signal value of “Set Color(96, 96, 96)”, as indicated by the color setting command 410. Note that the normal gray conversion processing is not limited thereto, and the blending ratio, conversion method, and so on may be changed as desired.

If the CPU 105 determines in step S301 that a drawing command for text is included, the processing advances to step S302, where the CPU 105 confirms the text size setting command (Set Text Size) included in the drawing command. The CPU 105 then determines whether or not the text size set therein is smaller than a predetermined size. If the set text size is smaller than the predetermined size, the processing advances to step S303, whereas if the set text size is not smaller than the predetermined size, the processing advances to step S304 and the above-described normal gray conversion processing is carried out.

In step S303, the CPU 105 carries out small-point text gray conversion processing. “Small-point text” is small text, e.g. 6-point and smaller. However, the visibility will vary depending on the outputting printer engine, and thus the threshold for small-point text may be made variable in accordance with how the printer engine can reproduce text. In the small-point text gray conversion processing of step S303, the signal values are adjusted in accordance with the density of color text.

For example, in the above-described example of FIG. 4, the letters “C” drawn by the 15th to 20th commands of the drawing command 400 are subject to this small-point text gray conversion processing. As such, in the post-processing drawing command 409, the color setting command “Set Color(255, 0, 0)” is converted to a color setting command 412 of “Set Color(85, 85, 85)”.

The foregoing assumes that the color setting command “Set Color(255, 0, 0)” is input as RGB values. However, similar density adjustment can be carried out even when signal values converted to gray by the application 201 or the printer driver 202 have been input.

A method of adjusting the density according to the first embodiment will be described next.

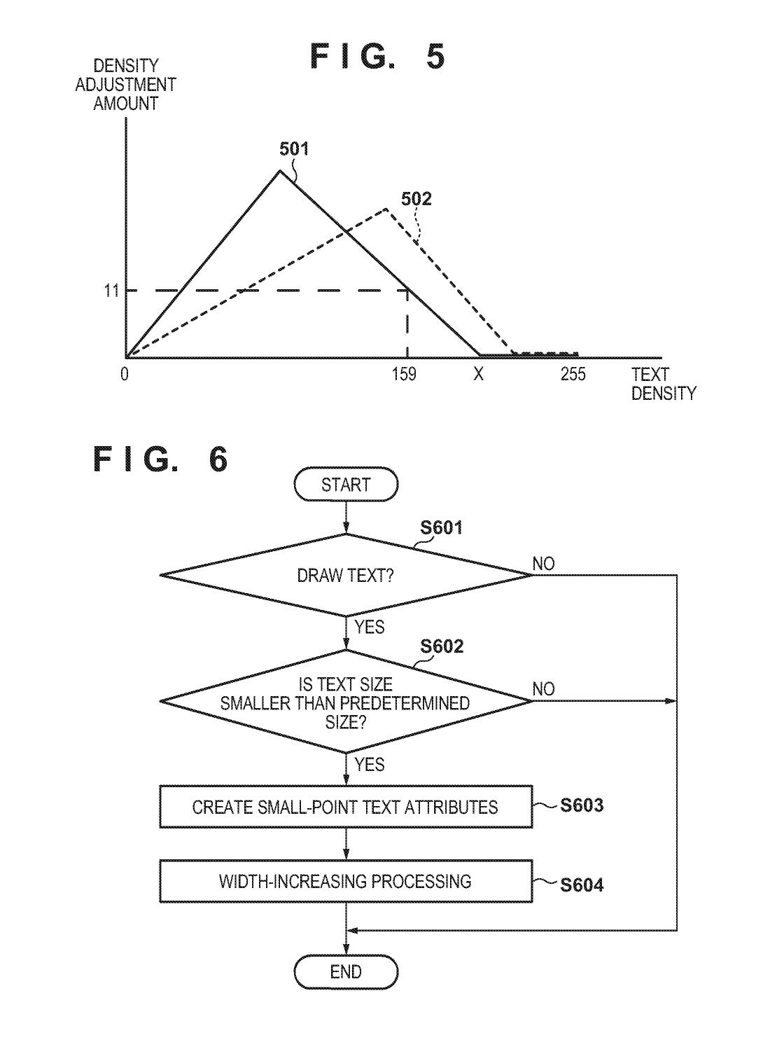

FIG. 5 is a diagram for describing an example of a density adjustment graph used to obtain a density adjustment amount, according to the first embodiment. The image forming apparatus 100 according to the first embodiment stores a table holding data expressed by this graph in the storage unit 107. The table takes a density value obtained by converting the gray-converted text into an RGB signal value as an input, and outputs a corresponding density adjustment amount.

In FIG. 5, numerals 501 and 502 denote examples of density adjustment settings. Here, the horizontal axis represents the density of the small-point text, and the vertical axis represents the density adjustment amount. “Density” refers to the darkness upon output, and can be thought of as a value obtained by inverting the RGB signal, for example. The present invention is not limited thereto, however, and as long as the method can adjust the darkness upon output, the RGB signal may be converted to an actual density value and adjusted, converted to a brightness value and adjusted, or the like.

The density of the RGB signal obtained by gray-converting the color setting command in the drawing command 400 indicated in FIG. 4 corresponds to the horizontal axis, and the density adjustment amount on the vertical axis is determined in accordance with the density. Then, the color setting command for the small-point text used when executing the gray conversion processing on the small-point text is determined by changing the gray-converted RGB value in accordance with the density adjustment amount. The three letters “CCC” 408, which are small-point text drawn by the above-described drawing command 400, will be described as an example here.

When normal gray conversion is carried out on the color setting command “Set Color(255, 0, 0)” for the small-point text “CCC” 408, the resulting RGB signal is (96, 96, 96). However, the small-point text “CCC” 408 is subject to the small-point text gray conversion processing, and thus the gray-converted RGB signal value is converted to a density (255-96=159). When the density adjustment amount corresponding to the density value “159” is found in the density adjustment setting denoted by the numeral 501 of the density adjustment graph, a value of “11” is found. It is therefore determined that an adjustment of a level of “11” is required for the color setting command 403 in the small-point text “CCC” 408. As a result, a color setting command “Set Color(85, 85, 85)” serves as the small-point text gray-converted signal value, as indicated by the color setting command 412 in the post-processing drawing command 409. Here, each RGB value of “85” is obtained by subtracting “11” from each value in the RGB signal (96, 96, 96) resulting from the above-described normal gray conversion. The density of the text output here is expressed by the inverse of the RGB value, and thus the text density of the small-point text “CCC” 408 is higher than the density of the text density of the other text strings 406 and 407 (the color is darker).

In the density adjustment graph in FIG. 5, there is little apparent difference in the densities of large-point text and small-point text when the density is extremely low or extremely high, and thus the density adjustment amount is reduced. In medium density ranges, the density adjustment amount is increased. Furthermore, the density adjustment graph ensures that the amount of toner consumed is not increased, regardless of whether or not density adjustment is carried out, if the density exceeds a predetermined signal value X. However, the control of the density adjustment amount is not limited thereto, and the density adjustment amount may be determined at a constant ratio depending on the density. Any adjustment amount that balances the apparent density difference between large-point text and small-point text may be used. The adjustment amount can also be changed depending on the properties of the printer engine, other image processing, the font, and so on. For example, a solid line density adjustment setting denoted by the numeral 501 may be applied to gothic and sans serif typefaces, whereas a dotted line density adjustment setting denoted by the numeral 502 may be applied to Mincho or serif typefaces.

According to the first embodiment as described thus far, when outputting color text in black and white, a drop in the visibility of small-point text, which will appear lighter than large-point text, can be prevented by increasing the density of the small-point text.

### Second Embodiment

Only processing different from that in the first embodiment will be described here. A feature of the second embodiment is that the visibility of small-point text is raised by executing a width-increasing processing on the small-point text so as to obtain a similar visibility as that of large-point text. Although the first embodiment describes processing in which the command analyzing module 204 converts the color setting command, the second embodiment assumes that the image adjustment module 206 carries out the width-increasing processing for increasing the width of small-point text. Note that the hardware configuration of the image forming apparatus 100 and so on according to the second embodiment are the same as those described in the above first embodiment, and thus descriptions thereof will be omitted.

FIG. 6 is a flowchart for describing a color conversion process performed by the image forming apparatus 100 according to the second embodiment. Note that the processing indicated in this flowchart is achieved by the CPU 105 deploying a program stored in the storage unit 107 into the RAM 106 and executing the deployed program.

Step S601 and step S602 in FIG. 6 determine whether or not the drawing command is a text drawing command and whether or not the text size set in the text size setting command is smaller than a predetermined size, in the same manner as step S301 and step S302, indicated in FIG. 3, according to the above-described first embodiment.

If the CPU 105 determines in step S602 that the text size set in the text size setting command is smaller than the predetermined size, the processing advances to step S603, whereas if such is not the case, the processing ends. In step S603, the CPU 105 creates attributes of the text determined to be small-point text. These attributes will be described here. “Attributes” are information indicating whether an object to be drawn is text, a graphic, an image, or the like. When a command is executed by the command execution module 205, a raster image is created along with an attribute image expressing the attributes of each pixel. Here, the attribute image has the same size as the raster image, and holds the attributes of each pixel. In the second embodiment, in step S603, the command execution module 205 generates the attributes of the small-point text and sends the attributes to the image adjustment module 206. Accordingly, in step S604, the CPU 105 functions as the image adjustment module 206 and executes the width-increasing processing on the attribute region of the small-point text. In this width-increasing processing, the width increase amount may be varied in accordance with the density of the text.

Additionally, the font setting command may be confirmed when generating the attributes of the small-point text in step S603, and it may be determined whether the text is a roman font or a Chinese character (kanji) font; a plurality of attributes for the small-point text may then be created in accordance with the fonts. The width-increasing processing for small-point text in step S604 may affect the proportions of the text, and thus the width-increasing processing may be reduced in strength for complex kanji fonts.

According to the second embodiment as described thus far, when outputting color text in black and white, an effect of preventing a drop in the visibility of small-point text, which will appear lighter than large-point text, is achieved by raising the visibility of the small-point text.

The configuration may be such that the user can select whether to apply one or both of the density adjustment of the above-described first embodiment and the width-increasing processing of the second embodiment. At this time, a selection screen (not illustrated) is displayed in the operation unit 104 and the processing to apply is selected in accordance with user instructions made through that screen.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-050289, filed Mar. 15, 2017, which is hereby incorporated by reference herein in its entirety.

What is claimed is:

1. An image processing apparatus comprising:
a memory device that stores a set of instructions; and
at least one processor that executes instructions stored in the memory device to function as:
an extracting unit that extracts, from color image data, an object having a first density and an object having a second density that is higher than the first density;
a determining unit that determines whether or not a size of the object having the first density and a size of the object having the second density, extracted by the extracting unit, are greater than a predetermined size; and
a converting unit that converts the color image data into monochromatic image data,
wherein the converting unit carries out conversion so that an object having the first density and a size less than or equal to the predetermined size has a higher density than an object having the first density and a size greater than the predetermined size;
and carries out conversion so that an object having the second density and a size less than or equal to the predetermined size has the same density as an object having the second density and a size greater than the predetermined size.

2. The image processing apparatus according to claim 1, wherein the color image data includes an RGB value; and
the converting unit converts an RGB value, obtained by converting the color image data into monochromatic image data, into a density value, uses a table holding a density adjustment amount corresponding to the density value to obtain an adjustment amount for increasing the density of the object having the first density, and uses that adjustment amount to change an RGB value obtained by converting the object having the first density into monochromatic image data.

3. The image processing apparatus according to claim 1, wherein the monochromatic image data is gray image data.

4. The image processing apparatus according to claim 1, wherein the object having the first density and the object having the second density are text.

5. The image processing apparatus according to claim 4, wherein the predetermined size used by the determining unit is a predetermined point number of text.

6. An image processing apparatus that generates monochromatic image data on the basis of print data including a command to draw a chromatic colored object, the apparatus comprising:
a memory device that stores a set of instructions; and
at least one processor that executes instructions stored in the memory device to function as:
a receiving unit that receives print data including at least a first drawing command for drawing a first chromatic colored object and a second drawing command for drawing a second chromatic colored object;
a determining unit that determines whether or not a size of the first chromatic colored object and a size of the second chromatic colored object are greater than a predetermined size;
a converting unit that converts the first drawing command into a third drawing command for drawing a monochromatic image of a first chromatic colored object determined to have a size less than or equal to the predetermined size so that the first chromatic colored object has a higher density, after being converted into a monochromatic image, than a first chromatic colored object determined to have a size greater than the predetermined size, and converts the second drawing command into a fourth drawing command for drawing a monochromatic image of a second chromatic colored object determined to have a size less than or equal to the predetermined size so that the second chromatic colored object has the same density, after being converted into a monochromatic image, as a second chromatic colored object determined to have a size greater than the predetermined size; and
a generating unit that generates monochromatic image data by executing the third drawing command and the fourth drawing command obtained from the conversion by the converting unit.

7. A method for controlling an image processing apparatus, the method comprising:
extracting, from color image data, an object having a first density and an object having a second density that is higher than the first density;
determining whether or not a size of the object having the first density and a size of the object having the second density, extracted in the step of extracting, are greater than a predetermined size; and
converting the color image data into monochromatic image data,
wherein the converting carries out conversion so that an object having the first density and a size less than or equal to the predetermined size has a higher density than an object having the first density and a size greater than the predetermined size, and carries out conversion so that an object having the second density and a size less than or equal to the predetermined size has the same density as an object having the second density and a size greater than the predetermined size.

8. The method according to claim 7, wherein the color image data includes an RGB value; and
the converting converts an RGB value, obtained by converting the color image data into monochromatic image data, into a density value, uses a table holding a density adjustment amount corresponding to that density value to obtain an adjustment amount for increasing the density of the object having the first density, and uses that adjustment amount to change an RGB value obtained by converting the object having the first density into monochromatic image data.

9. The method according to claim 7, wherein the monochromatic image data is gray image data.

10. The method according to claim 7, wherein the object having the first density and the object having the second density are text.

11. The method according to claim 10, wherein the predetermined size used in the determining is a predetermined point number of text.

12. A method for controlling an image processing apparatus that generates monochromatic image data on the basis of print data including a command to draw a chromatic colored object, the method comprising:
receiving print data including at least a first drawing command for drawing a first chromatic colored object and a second drawing command for drawing a second chromatic colored object;
determining whether or not a size of the first chromatic colored object and a size of the second chromatic colored object are greater than a predetermined size;
converting the first drawing command into a third drawing command for drawing a monochromatic image of a first chromatic colored object determined to have a size less than or equal to the predetermined size so that the first chromatic colored object has a higher density, after being converted into a monochromatic image, than a first chromatic colored object determined to have a size greater than the predetermined size, and converting the second drawing command into a fourth drawing command for drawing a monochromatic image of a second chromatic colored object determined to have a size less than or equal to the predetermined size so that the second chromatic colored object has the same density, after being converted into a monochromatic image, as a second chromatic colored object determined to have a size greater than the predetermined size; and
generating monochromatic image data by executing the third drawing command and the fourth drawing command obtained from the conversion in the converting.

13. A non-transitory computer-readable storage medium storing a program for causing a processor to execute a method for controlling an image processing apparatus, the method comprising:
extracting, from color image data, an object having a first density and an object having a second density that is higher than the first density;
determining whether or not a size of the object having the first density and a size of the object having the second density, extracted in the step of extracting, are greater than a predetermined size; and
converting the color image data into monochromatic image data,
wherein the converting carries out conversion so that an object having the first density and a size less than or equal to the predetermined size has a higher density than an object having the first density and a size greater than the predetermined size, and carries out conversion so that an object having the second density and a size less than or equal to the predetermined size has the same density as an object having the second density and a size greater than the predetermined size.
